(19) United States
(12) Patent Application Publication
(10) Pub. No.: US 2018/0294456 A1
(43) Pub. Date: Oct. 11, 2018

(54) Microporous Polyimide Film and Process for Producing the Same

(71) Applicant: SK Innovation Co., Ltd., Seoul (KR)

(72) Inventors: Gwi Gwon Kang, Daejeon (KR); Dong Hoon Lee, Daejeon (KR); Jae Kyu Jin, Daejeon (KR)

(21) Appl. No.: 15/942,853

(22) Filed: Apr. 2, 2018

(30) Foreign Application Priority Data
Apr. 5, 2017 (KR) 10-2017-0043971

(51) Int. Cl. H01M 2/16; H01M 2/14; C09D 177/00

(52) U.S. Cl. CPC H01M 2/166; C09D 177/00; H01M 2/145

(57) ABSTRACT

A microporous polyimide-based film having excellent strength, permeability, and thermal stability is used as a separator for a lithium ion secondary battery, and a method of producing the same is provided.

### CROSS-REFERENCE TO RELATED APPLICATION

This application claims priority to Korean Patent Application No. 10-2017-0043971 filed Apr. 5, 2017, the disclosure of which is hereby incorporated in its entirety by reference.

### BACKGROUND OF THE INVENTION

The present disclosure relates to a microporous polyimide-based film used as a separator for a battery and a method of producing the same, and more specifically, to a microporous film using a polyimide-based resin having thermal stability, even at a temperature of 200° C. or more, securing gas permeability by forming a pore structure connected in a thickness direction, and having mechanical strength and a pore size appropriate to be applied to a separator for a battery.

As the use of lithium ion secondary batteries has expanded to encompass electric vehicles and high-capacity IT devices, there has been a demand for higher capacity, higher output, and higher safety of batteries. In order to meet the requirements for high capacity and high output of secondary batteries, there is growing demand for high strength in separators, high permeability, improvements of thermal stability, and the like, as well as for improving characteristics of a separator for electrical safety of a secondary battery during charging and discharging. In detail, in the case of a separator for a lithium ion secondary battery, a high degree of mechanical strength is required for improving safety in a battery manufacturing process and during the use, and high permeability is also required for improving capacity and power. Furthermore, excellent thermal stability is also required. For example, if thermal stability of a separator is insufficient, a temperature inside a battery may increase. If a separator is damaged or deformed by external force, a short circuit between electrodes may occur and the risk of fire caused by overheating may increase.

Moreover, as the application range of secondary batteries is expanded to electric vehicles and the like, securing the safety of such batteries becomes an important requirement due to the risk of overcharging, and characteristics of a separator, capable of withstanding electric pressure caused by overcharging, are required.

More specifically, high strength is required to prevent damage to a separator, which may occur during a process of manufacturing a battery, damage to a separator due to a dendrite, generated in an electrode during charging and discharging, and a short-circuit between electrodes. Moreover, if strength of a separator is weak at high temperature, a short-circuit caused by film breakage may also occur. In this case, as a result thereof, heat generation/ignition/explosion caused by a short circuit between electrodes may occur.

High permeability is required to improve capacity and power of a lithium secondary battery. There is increasing demand for a separator having high permeability in the trend for high capacity and high output of a lithium secondary battery.

On the other hand, thermal safety of a battery may be affected by a shutdown temperature of a separator, a meltdown temperature, a heat shrinkage ratio, and the like. Here, at high temperature, the heat shrinkage ratio of the separator has a significant effect on thermal stability of a battery. If the heat shrinkage ratio is significant, when a temperature inside a battery is increased, a portion of an electrode is exposed during a shrinkage process, and thus a short-circuit between electrodes may occur. As a result of such a short-circuit, heat generation/ignition/explosion, and the like may occur. Therefore, at high temperature, demand for a low heat shrinkage ratio is increasing.

A microporous polyolefin-based film currently used as a separator for a lithium ion secondary battery has a high heat shrinkage ratio at a temperature of 165° C. or more, which is a melting point of a polyolefin-based resin. A recent technique for improving heat shrinkage properties is a technique of introducing a layer containing inorganic particles and/or a binder polymer to a cross-section or both sides of a polyolefin-based separator.

Japan Patent Laid-Open Publication No. 1999-080395, Korean Patent Laid-Open Publication No. 2001-0091048, and Korean Patent Publication No. 0775310 disclose a composite separator having a coating layer with permeability, while containing a high heat-resistant polymeric binder and an inorganic fine particle on a one side or both sides of a separator. The composite separator may not maintain a shape of a separator at a temperature of 200° C. or more, at which polyolefin-based resin is completely melted, and thus sufficient safety may not be secured in a high capacity battery.

To date, research has been conducted to develop a separator for a lithium ion secondary battery using polyimide-based resin of which a melting temperature or a glass transition temperature is 200° C. or more, and which is capable of maintaining a shape of a separator at a temperature of 200° C. or more, so as to improve safety of a battery.

In Japan Patent Publication No. 5916498, Japan Patent Publication No. 3687448, and Japan Patent Laid-Open Publication No. 2014-132057, manufacturing of a polyimide-based porous film using a non-solvent, a phase separation agent, or the like is mentioned. However, the present inventions, described above, have the problem in which permeability may not be secured by a dense layer formed on a film surface (a layer having no pore formed on a surface) and a non-continuous pore structure. Moreover, in Japan Patent Laid-Open Publication No. 2013-064122, a method of removing the dense layer described above is mentioned, but whether gas permeability can be secured thereby is not mentioned. Moreover, in this case, not only is it technically difficult to uniformly etch a thin film product to be applied as a separator for a battery, but productivity may also be deteriorated. Therefore, it is difficult to apply the method described above.

In Japan Patent Laid-Open Publication No. 2007-169661 and Japan Patent Laid-Open Publication No. 2003-257484, in a process of producing a polyimide-based porous film, a porous film, a solvent exchange rate adjuster layer, or the like, is attached to or formed on a surface, and thus, a surface pore is formed. Then, the porous film, the adjuster layer, or the like is removed, and thus the surface pore may be secured. Here, a method of securing a surface pore, as described above, is mentioned, but whether permeability is able to be secured by surface pore formation is not mentioned. Moreover, due to the complexity of the process described above, there are limitations in actual application or high cost problems.

### RELATED ART DOCUMENT

### Patent Document

### (Patent Document 1) Japan Patent Laid-Open Publication No. 1999-080395

### (Patent Document 2) Korean Patent Laid-Open Publication No. 2001-0091048

### (Patent Document 3) Korean Patent Publication No. 0775310

### (Patent Document 4) Japan Patent Publication No. 5916498

### (Patent Document 5) Japan Patent Publication No. 3687448

### (Patent Document 6) Japan Patent Laid-Open Publication No. 2014-132057

### (Patent Document 7) Japan Patent Laid-Open Publication No. 2013-064122

### (Patent Document 8) Japan Patent Laid-Open Publication No. 2007-169661

### (Patent Document 9) Japan Patent Laid-Open Publication No. 2003-257484

### SUMMARY OF THE INVENTION

As described above, according to the related art, a microporous polyimide-based film, having a low heat shrinkage ratio at high temperature for securing safety of a high capacity/high power secondary battery and having permeability to be used as a separator for a battery, may not be produced.

An aspect of the present disclosure provides a microporous polyimide-based film having strength and permeability to be used as a separator for a lithium ion secondary battery while maintaining a shape and having a low heat shrinkage ratio at a temperature of 200° C. or more.

According to an aspect of the present disclosure, a method of producing a microporous polyimide-based film includes: applying a polymer solution including poly(amic acid), a solvent for dissolving the poly(amic acid), a phase separation agent for phase-separating the poly(amic acid), inorganic particles with a hydrophobized surface, an imidizing catalyst, and a dehydrating agent to a base material; producing a phase-separated structure by drying the base material; removing the phase separation agent from the phase-separated structure and producing a microporous film; and imidizing unreacted poly(amic acid) by drying the microporous film.

The producing the phase-separated structure may be performed by conducting heat-drying for 1 to 30 minutes at a temperature of 60° C. to 150° C.

The method of the present invention may further include: peeling the phase-separated structure from the base material before the phase separation agent is removed.

The removing the phase separation agent may be performed by conducting heat-drying for 5 to 60 minutes at a temperature of 150° C. to 400° C.

The removing the phase separation agent may be performed by extraction using one or more extractants selected from the group consisting of toluene, ethanol, ethyl acetate, heptane, liquefied carbon dioxide, and supercritical carbon dioxide.

A residual phase separation agent in the microporous polyimide-based film may be equal to or less than 1 wt % of a microporous film in which imidization is completed.

The inorganic particles with a hydrophobized surface may have a specific surface area of 20 m²/g to 500 m²/g.

According to another aspect of the present disclosure, a microporous polyimide-based film includes 4 wt % to 30 wt % of inorganic particles with a hydrophobized surface, wherein a film thickness is 10 μm to 50 μm, puncture strength is 0.05 N/μm to 0.30 N/μm, permeability standardized at a thickness of 20 μm is 50 to 500 sec/100 cc, porosity is 40% to 65%, an average pore size measured using a half-dry method is 20 nm to 100 nm, a maximum pore size measured using a bubble point method is equal to or less than 300 nm, and a shrinkage ratio at 200° C. is equal to or less than 5%.

The inorganic particles with a hydrophobized surface may have a specific surface area of 20 m²/g to 500 m²/g.

In the microporous polyimide-based film, a film thickness may be 10 μm to 30 μm, puncture strength may be 0.05 N/μm to 0.30 N/μm, permeability standardized at a thickness of 20 μm may be 50 to 300 sec/100 cc, porosity may be 45% to 60%, an average pore size measured using a half-dry method may be 20 nm to 100 nm, a maximum pore diameter measured using a bubble point method may be equal to or less than 200 nm, and a shrinkage ratio at 200° C. may be less than 3%.

According to another aspect of the present disclosure, a battery is produced using the microporous polyimide-based film as a separator.

### BRIEF DESCRIPTION OF THE DRAWINGS

The above and other aspects, features, and advantages of the present disclosure will be more clearly understood from the following detailed description taken in conjunction with the accompanying drawings, in which:

FIGS. 1A-1C are electron microscopy images of a surface and a cross-section of a microporous film of Example 1, FIG. 1A illustrates an air surface, FIG. 1B illustrates a PET surface, and FIG. 1C illustrates a cross-section;

FIGS. 2A-2C are electron microscopy images of a surface and a cross-section of a microporous film of Comparative Example 1, FIG. 2A illustrates an air surface, FIG. 2B illustrates a PET surface, and FIG. 2C illustrates a cross-section;

FIGS. 3A-3C are electron microscopy images of a surface and a cross-section of a microporous film of Comparative Example 2, FIG. 3A illustrates an air surface, FIG. 3B illustrates a PET surface, and FIG. 3C illustrates a cross-section; and

FIGS. 4A-4C are electron microscopy images of a surface and a cross-section of a microporous film of Comparative Example 3, FIG. 4A illustrates an air surface, FIG. 4B illustrates a PET surface, and FIG. 4C illustrates a cross-section.

### DESCRIPTION OF THE INVENTION Hereinafter, an embodiment of the present invention will be described.

In general, in poly(amic acid) mixed with a phase separation agent, a non-continuous pore structure is formed and a surface pore is not formed. However, the inventors have found that a small and connected pore structure and a pore may be formed on a surface of a film by controlling the phase separation carried out by drying a solvent, when inorganic particles with a hydrophobized surface, an imidizing catalyst, and a dehydrating agent are added to a polymer solution containing poly(amic acid), a solvent for dissolving the poly(amic acid), a phase separation agent for phase-separation from the poly(amic acid), and the like, and solvent drying conditions are appropriately selected.

Therefore, a method for producing a microporous polyimide-based film of the present invention includes: applying a polymer solution containing poly(amic acid), a solvent for dissolving the poly(amic acid), a phase separation agent for phase-separation from the poly(amic acid), inorganic particles with a hydrophobized surface, an imidizing catalyst, and a dehydrating agent to a base material; producing a phase-separated structure by drying the base material; producing a microporous film by removing the phase separation agent from the phase-separated structure; and imidizing unreacted poly(amic acid) by drying the microporous film.

The poly(amic acid) may be produced by condensation polymerization of aromatic dianhydrides and aromatic diamines in the presence of a solvent. The condensation polymerization reaction is preferably carried out in a nitrogen atmosphere, and may be carried out at room temperature or may be carried out while a temperature increases as required to increase a reaction rate and to polymerize a high molecular weight polymer.

The aromatic dianhydrides may include one or two or more monomers selected from pyromellitic dianhydride (PMDA), 3,3′,4,4′-biphenyl tetracarboxylic dianhydride (s-BPDA), 2,3,3′,4′-biphenyl tetracarboxylic dianhydride (a-BPDA), 3,3′,4,4′-benzophenone tetracarboxylic dianhydride (BTDA), 4,4′-oxydiphthalic anhydride (ODPA), 2,2′-bis-4-(3,4-dicarboxyphenoxy) phenylpropane dianhydride (BPADA), 2,2′-bis-(3,4-dicarboxyphenyl)hexafluoropropane dianhydride (6FDA), 2,3,6,7-naphthalene tetracarboxylic dianhydride (NTCDA), and the like, but is not limited thereto.

The aromatic diamines may include one or two or more monomers selected from m-phenylenediamine (m-PDA), p-phenylenediamine (p-PDA), 4,4′-diamino diphenylether (ODA), 3,4′-diamino diphenylether, 3,3′-diamino diphenylether, 3,3′-dimethyl-4,4′-diaminodiphenyl ether, 3,3′-dimethoxy-4,4′-diaminodiphenyl ether, 4,4′-diaminobiphenyl-2,2′-bis(trifluoromethyl)benzidine (TFMB), 2,2-bis(4-aminophenyl) propane (BAPP), 4,4′-diaminodiphenylsulfone, 3,3′-diaminodiphenylsulfone, 1,4-bis(4-amino phenoxy) benzene (TPE-Q), 1,3-bis(4-amino phenoxy) benzene (TPE-R), and the like, but is not limited thereto.

The aromatic dianhydrides and the aromatic diamines are polymerized in a molar ratio of 1:0.95 to 1:1.05, preferably in a molar ratio of 1:0.97 to 1:1.03, more preferably in a molar ratio of 1:0.99 to 1:1.01. In this case, it is advantageous in terms of mechanical properties and heat resistance of a polymer after an imidization process. If the molar ratio is outside of the range described above, viscosity is lowered after polymerization, so a problem in which a process may be difficult to undertake may occur.

Preferably, poly(amic acid) of the present invention may be represented by the following chemical formula.

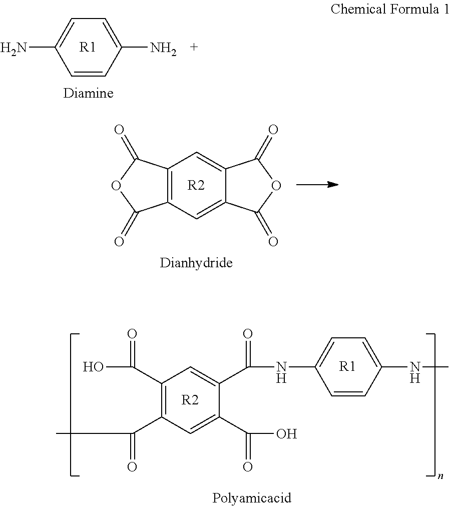

For the phase separation agent for phase-separation from poly(amic acid), ester such as dimethylphthalate, dibutylphthalate, dioctylphthalate, or the like, ether such as diethylene glycol, diethyleneglycol monomethyl ether, triethyleneglycol monomethyl ether, triethyleneglycol dimethyl ether, tetraethyleneglycol dimethyl ether, or the like, alcohol having the number of carbon atoms equal to or more than 10 such as decanol, dodecanol, or the like may be used alone or as a mixture.

Preferably, in a stage of producing a phase-separated structure of the present invention, as a solvent is evaporated, the phase separation agent causes fine phase separation from poly(amic acid), so a boiling point of a phase separation agent is preferably different from a boiling point of a solvent . For example, the phase separation agent may have a boiling point, higher than that of the solvent by 30° C. or more, preferably, a boiling point higher than that of the solvent by 50° C. or more. If the boiling point of the phase separation agent is higher than the solvent by less than 30° C., the solvent and the phase separation agent are evaporated together during a drying process, so it is difficult to induce phase separation.

Meanwhile, in a subsequent process, when a phase separation agent is removed by evaporation through heating, a boiling point of the phase separation agent is preferably equal to or less than 400° C. When the boiling point thereof is higher than 400° C., removal of the phase separation agent is carried out at high temperature above 400° C. and polyimide resin is deformed during a removal process, so physical properties may be lowered.

The content of the phase separation agent with respect to poly(amic acid) is preferably in a range of 30 wt % to 75 wt %, more preferably in a range of 50 wt % to 75 wt %, and further more preferably in a range of 60 wt % to 75 wt %. If the content of the phase separation agent is less than 30 wt %, due to lower porosity, a connected pore may not be sufficiently secured, so permeability may be low. If the content of the phase separation agent exceeds 75 wt %, pores may be excessively formed, so it may be difficult to secure strength.

The inorganic particles may be at least one selected from the group consisting of titanium oxide particles, silica particles, alumina particles, barium titanate particles, barium sulfate particles, indium tin oxide particles, zirconium oxide particles, copper oxide particles, iron oxide particles, carbon particles, and carbon nanotubes.

It is preferable that a surface of inorganic particles be hydrophobically treated, and thus, affinity to a polar solvent is weakened. If the surfaces of inorganic particles are not hydrophobically treated and affinity to a polar solvent is high, a degree of connection between a pore on a surface and an internal pore may be low, so it may be difficult to secure sufficient permeability.

Moreover, a specific surface area of the inorganic particles, measured using a BET method, is preferably 20 m²/g to 500 m²/g. If the specific surface area is less than 20 m²/g, sufficient viscosity of a polymer solution may not be secured, so it may be difficult to secure a pore on a surface and an internally connected pore. If the specific surface area exceeds 500 m²/g, it may be difficult to disperse in a polymer solution, so it may be difficult to produce a uniform polymer solution.

The content of inorganic particles with respect to poly(amic acid) is preferably 4 wt % to 30 wt %, more preferably 6 wt % to 26 wt %, and further more preferably 8 wt % to 22 wt %. If the content of inorganic particles is less than 4 wt %, it may be difficult to secure a pore on a surface and an internally connected pore, so permeability may not be secured. If the content of inorganic particles exceeds 30 wt %, there may be an advantage of securing sufficient permeability, while it may be difficult to secure strength due to an excessive amount of inorganic particles.

The imidizing catalyst may be a tertiary amine and an organic base such as trimethyl amine, triethyl amine, triethylene diamine, tributyl amine, dimethylaniline, pyrindine, α-picoline, β-picoline, γ-picoline, isoquinoline, imidazole, 2-ethyl-4-methyl imidazole, 2-phenyl imidazole, N-methyl imidazole, lutidine, and the like.

The addition amount of the imidizing catalyst, with respect to amic acid of poly(amic acid), is preferably 0.02 to 0.30 molar equivalents, more preferably 0.02 to 0.25 molar equivalents, and further more preferably 0.02 to 0.20 molar equivalents. If the addition amount of the imidizing catalyst is less than 0.02 molar equivalents, it may be difficult to secure a connected pore structure. If the addition amount of the imidizing catalyst exceeds 0.30 molar equivalents, it may be difficult to secure sufficient pore size.

The dehydrating agent maybe organic carboxylic acid anhydride, N,N′-dialkylcarbodiimide, a lower fatty acid halide, a halogenated lower fatty acid anhydride, arylsulfonic acid dihalide, thionyl halide, or the like. The dehydrating agent may be at least one or more thereamong, and is preferably organic carboxylic acid anhydride.

The organic carboxylic acid anhydride may be acetic anhydride, propionic anhydride, butyric anhydride, aromatic monocarboxylic acid anhydride, formic anhydride, anhydride of aliphatic ketenes, intermolecular anhydride and mixture thereof, and the like.

The addition amount of anhydride, with respect to amic acid of poly(amic acid), is preferably 1 to 4 molar equivalents, more preferably, 1 to 3 molar equivalents, and further more preferably, 1 to 2 molar equivalents. If the addition amount of anhydride is less than 1 molar equivalent, it is difficult to secure a connected pore structure. If the addition amount of anhydride exceeds 4 molar equivalents, it is difficult to secure sufficient pore size, so releasing properties may not be secured in a support.

The solvent for dissolving poly(amic acid) maybe a polar solvent such as N-methyl-2-pyrrolidone (NMP), N,N-dimethylacetamide (DMAc), N,N-dimethylformamide (DMF), dimethylsulfoxide (DMSO), and the like.

Moreover, the solid content of a poly(amic acid) solution may be preferably in a range of 5 wt % to 30 wt %, more preferably in a range of 5 wt % to 25 wt %, and further more preferably in a range of 10 wt % to 20 wt %. If the solid content is less than 5 wt %, formation of a uniform film is impossible. If the solid content exceeds 30 wt %, gas permeability may not be secured.

A method of producing a microporous polyimide-based film of the present invention may include applying a polymer solution in which the compositions described above are mixed to a base material, and producing a phase-separated structure by drying the base material. In this case, in the producing a phase-separated structure, an imidization reaction with a fine phase separation may occur.

The base material may be a plastic film such as PET, PE, PP, or the like, a glass plate, a metal plate, such as stainless steel, copper, and aluminum, or the like, without limitations, as long as the base material has a smooth surface. Moreover, so as to continuously produce a phase-separated structure, a base material on a belt may be used.

A method of applying the polymer solution to the base material may be a wire bar method, a kiss coating method, a gravure coating method, a die coating method, a method using an applicator, a method using a knife coater, or the like, without limitation.

Moreover, in the producing a phase-separated structure, the polymer solution applied to the base material is heated and dried to evaporate a solvent, so imidization of fine phase separation and poly(amic acid) is carried out and a phase-separated structure may be produced.

During the heat-drying, while the solvent is evaporated, phase separation occurs, so a pore structure is formed. In this case, the imidization reaction is controlled depending on a heating temperature, so formation of a surface dense layer, which occurs during evaporation of a solvent and phase separation, may be prevented. The temperature is not particularly limited, and is preferably adjusted in consideration of a type of solvent used, an air volume of a drying oven, the content of an imidizing agent, and the like. According to the related art, the heat-drying is preferably carried out for 1 to 30 minutes at 60° C. to 150° C.

Moreover, the method of the present invention may further include drying and/or imidizing the solvent, performed at a temperature higher than a primary drying temperature, so as to improve strength of a phase-separated structure, produced through the drying.

Moreover, the method of the present invention may include producing a microporous film by removing the phase separation agent, which is fine phase separated from the phase-separated structure. In this case, before the phase separation agent is removed, the phase-separated structure is peeled from the base material. In this regard, when removal of the phase separation agent is conducted after the phase-separated structure is peeled therefrom, removal efficiency may be better. The method of removing the phase separation agent from the phase-separated structure may be a method of evaporating by heating, a method of decomposing by heating, a method of extracting with a solvent, or the like without limitation, and may be conducted by combining the methods described above.

In the method of evaporating or decomposing by heating the phase separation agent, a temperature may be changed depending on a boiling point of the phase separation agent or a pyrolysis temperature. According to the related art, the temperature may be selected within a range of a temperature, in which polyimide-based resin is not modified, such as a range of 150° C. to 400° C. Moreover, the method described above may be carried out under reduced pressure so as to improve removal efficiency.

In the method of extracting the phase separation agent with a solvent, an extractant may not dissolve poly(amic acid) but may effectively dissolve a phase separation agent. For example, the extractant may be an organic solvent such as toluene, ethanol, ethyl acetate, a heptane, or the like, liquefied carbon dioxide, supercritical carbon dioxide, or the like. When an organic solvent having a boiling point lower than that of the phase separation agent, among the organic solvents described above, is selected, there is an advantage that a drying process may be convenient when a microporous film is dried and thus a solvent is evaporated in a subsequent process after a phase separation agent is extracted.

Moreover, the method of the present invention may include imidizing unreacted poly(amic acid) by drying the microporous film. Preferably, the drying may be carried out by heat-drying, and a heating temperature is preferably the highest temperature at which modification of the polyimide resin, caused by heat, does not occur. For example, the imidization process may be carried out for 5 to 60 minutes at 250° C. to 400° C. The imidization process may be conducted simultaneously with the process of removing a phase separation agent, or may be conducted in stages.

As the imidization process is carried out while heat is applied, a residual phase separation agent may be removed. After the imidization process is completed, a residual phase separation agent in a microporous polyimide-based film is preferably equal to or less than 1 wt %.

The microporous polyimide-based film, produced using the method of the present invention described above, has excellent heat resistance, has a small and uniform pore size, and has excellent strength and permeability. In detail, 4 to 30 wt % of inorganic particles with a hydrophobized surface is included, a film thickness is 10 μm to 50 μm, puncture strength is 0.05 N/μm to 0.30 N/μm, permeability standardized at a thickness of 20 μm is 50 to 500 sec/100 cc, porosity is 40% to 65%, an average pore size measured using a half-dry method is 20 nm to 10 0nm, a maximum pore size measured using a bubble point method is equal to or less than 300 nm, a shrinkage ratio at 200° C. is equal to or less than 5%, and a pore structure connected in a thickness direction is included, and thus a microporous polyimide-based film in which gas permeability is secured may be provided.

A specific surface area of inorganic particles with a hydrophobized surface may be 20 m²/g to 500 m²/g. In addition, a film thickness is 10 μm to 50 μm, and preferably 10 μm to 30 μm. If the thickness is less than 10 μm, film strength is low, and thus process stability may not be secured in a process of producing a microporous film and a process of assembling a battery. If the thickness exceeds 50 μm, permeability is deteriorated, and a volume of a separator inside a battery is large, and thus it may not be applicable to a high power/high capacity battery.

Permeability standardized at a thickness of 20 μm is 50 to 500 sec/100 cc, and further preferably 50 to 300 sec/100 cc. If the permeability is less than 50 sec/100 cc, due to high porosity and a large pore size, battery cycle performance and overcharging safety may not be secured. If the permeability exceeds 500 sec/100 cc, due to low permeability, it may not be applicable to a high power/high capacity battery.

Puncture strength is 0.05 N/μm to 0.30 N/μm, and further preferably 0.10 N/μm to 0.30 N/μm. If the puncture strength is less than 0.05 N/μm, film strength is low, and thus process stability may not be secured in a process of producing a microporous film and a process of assembling a battery, while resistibility to a needle-shape such as a dendrite, generated during charging and discharging of a battery, is low, and thus, battery safety may not be secured. If the puncture strength exceeds 0.30 N/μm, due to low porosity and low permeability, it may be difficult to secure a battery performance.

Porosity is preferably 40% to 65%, and further preferably 45% to 60%. If the porosity is less than 40%, a connected pore structure is not secured, and thus permeability and electrolyte impregnation are lowered, so characteristics of a battery are deteriorated. If the porosity exceeds 65%, strength sufficient for securing battery stability may not be obtained.

An average pore size measured using a half-dry method is 20 nm to 100 nm, and further preferably 30 nm to 90 nm. If the average pore size is less than 20 nm, the number of ions, passing simultaneously, is limited, and thus the output of a battery may not be improved beyond a certain level. Moreover, in this case, due to an impurity generated during a charging and discharging process, a pore maybe easily blocked, and thus, the capacity of a battery may be lowered and battery cycle performance may not be secured. If the average pore size exceeds 90 nm, due to an excessive pore size, lithium plating, or the like, occurs on an anode surface, and thus battery cycle performance and overcharging safety may not be secured.

A maximum pore size measured using a bubble point method is equal to or less than 300 nm, and preferably equal to or less than 200 nm. If the maximum pore size exceeds 300 nm, a material of a battery electrode may pass through a large pore, and thus battery safety may be deteriorated. Moreover, in this case, a dendrite or the like may be easily generated during a charging and discharging process, and thus battery safety may not be secured and properties of breakdown voltage may also be deteriorated.

In addition, a shrinkage ratio at 200° C. is preferably equal to or less than 5%, while a shrinkage ratio at 250° C. is further preferably equal to or less than 3%. If the shrinkage ratio exceeds 5%, when a temperature inside a battery increases due to influence inside/outside a battery, a short circuit of an electrode may occur due to shrinkage of a separator. In this case, due to the short circuit, heat generation/ignition/explosion and the like of the battery may occur, and thus battery safety may not be secured.

Another embodiment of the present invention may provide a battery produced using the microporous polyimide-based film as a separator. The microporous polyimide-based film of the present invention has gas permeability due to a pore structure connected in a thickness direction and excellent strength, a pore structure capable of securing a battery performance, thermal stability capable of securing battery safety, a low shrinkage ratio, and the like, and thus may be widely applied to a lithium ion secondary battery having high capacity/high power/high safety.

Embodiments of the present invention will be described below in detail, but the present invention is not limited to the embodiments below.

### EXAMPLE

1. Film Thickness

A thickness of a final product was measured by using TESA Mu-Hite Electronic Height Gauge by the TESA Company at a measuring pressure of 0.63N.

2. Puncture Strength

A pin with a diameter of 1 mm and a radius of curvature 0.5 mm was installed in a Universal Testing Machine (UTM) by the Instron Company, and strength of the separator was measured when the separator was broken by the pin at a movement rate of 120 mm/min at a temperature of 23° C. Here, the value standardized by thickness was expressed as N/μm.

3. Gas Permeability

Gas permeability was measured according to JIS P8117 by using Gurley type densometer (G-B2C) by the Toyoseiki Company. A Gurley number per thickness of 20 μm to compare permeability levels of microporous films having different thicknesses was indicated as permeability.

4. Average Pore Size and Maximum Pore Size

An average pore diameter and a maximum pore diameter were measured by a porometer (CFP-1500-AEL, PMI Company) according to ASTM F316-03. An average pore size was measured by a half-dry method and a maximum pore size was measured by a bubble point method. For measurement of a pore size, Galwick solution (surface tension: 15.9 dyne/cm) by the PMI Company was used.

5. Shrinkage Ratio

A composite porous film was cut to have a size of 10 cm×10 cm. The composite porous film was inserted into Teflon films and placed between glass plates having a size of 11 cm×11 cm and a thickness of 3 mm, and was then placed inside an oven (OF-12GW, Jeio Tech Company) of which a temperature was stabilized at 200° C., followed by being left for 60 minutes. Then, a change in size was measured and the shrinkage ratio was calculated. The shrinkage ratio was calculated by the following equation.

Shrinkage ratio (%)=100×(100 mm−length after being left at 200° C.)/100 mm

6. Content of Inorganic Particles

The content of inorganic particles in a microporous film was measured by using a thermal gravimetric analysis (TGA). A device therefor was TGA Q500 by the TA Instruments Company. A sample of a microporous film, having a total weight of 5 mg to 10 mg, was placed on an aluminum pan, and was then heated to 700° C. at a heating rate of 5° C./min in the air. A ratio of the weight before heating a microporous film to the weight after heating the microporous film was determined as the content of inorganic particles.

7. Porosity

Porosity was calculated by calculating the volume of a separator. A sample was cut into a rectangle (thickness: T μm) having a size of A cm×B cm, and weighed, and thus the porosity was calculated by a ratio of weight of a mixture of resin and inorganic particles to weight (M g) of separator, the mixture and the separator having the same volume calculated according to the content of inorganic particles. A mathematical equation therefor is as follows.

Porosity (%)=100×{1−M×10000/(A×B×T×ρ)}

Wherein, ρ (g/cm³) is a density of a mixture of the resin and inorganic particles, to which the content of inorganic particles is applied.

8. Identifying Shape of Surface and Cross-Section

A shape was observed for identifying a pore structure of a surface and a cross-section of a microporous film by using a field emission scanning electron microscopy (FE-SEM). A device therefor was FE-SEM s-4800 by the Hitachi Company. A platinum (Pt) coating was performed to secure a clear shape, while a sample for identification of a cross-section was broken in the presence of liquid nitrogen, and thus a clear cross-section was secured.

### Manufacture Example 1

To polymerize a poly(amic acid) solution, 95.73 g of 4,4-diaminodiphenyl ether (ODA) was added to 758.44 g of DMAc, a reactor temperature was maintained at 30° C., and a mixture was stirred for 1 hour while nitrogen flows. After confirming that ODA was completely dissolved, 101.15 g of pyromellitic dianhydride (PMDA) was slowly added over 10 minutes. After stirring for about 12 hours, polymerization was sufficiently carried out. Then, during stirring, a solution, in which 3.13 g of PMDA was dissolved in 41.56 g of DMAc, was prepared in advance, and the solution was slowly added to a reactor and viscosity was confirmed. Until the viscosity reaches 1000 poise, a PMDA solution was added. After a PMDA solution was finally added, stirring was carried out sufficiently for 12 hours or more again, and thus polymerization of a poly(amic acid) solution was completed.

### Example 1

4 g of N,N-dimethylacetamide (DMAc) was added to 20 g of the poly(amic acid) solution as a solvent, 0.6 g of hydrophobic fumed silica (AEROSIL® R972 from Evonik Industries) with a specific surface area of 90 m²/g to 130 m²/g, 9 g of dibutylphthalate as a phase separation agent, 0.19 g of isoquinoline as an imidizing agent, and 4 g of acetic anhydride as a dehydrating agent were added thereto, and then the foregoing composition was stirred to produce a transparent and uniform solution.

The polymer solution was applied to a PET film using a bar for coating and an applicator, and was then dried for 8 minutes at 80° C. Then, removal of DMAc, a solvent, and some imidization were carried out to produce a microphase-separated structure. A residual solvent was removed from the phase-separated structure, and additional drying was carried out for 10 minutes at 120° C. to conduct additional imidization. The phase-separated structure produced as described above was peeled from the PET film. Then, while the phase-separated structure was fixed to a pin tenter, removal of a phase separation agent and additional imidization were carried out at 350° C. for 20 minutes in a nitrogen atmosphere to produce a microporous polyimide-based film. The obtained physical properties of the microporous film are tabulated in Table 1 below.

### Example 2

5 g of N,N-dimethylacetamide (DMAc) was added to 20 g of the poly(amic acid) solution as a solvent, 0.9 g of hydrophobic fumed silica (AEROSIL® R974 from Evonik Industries) with a specific surface area of 150 m²/g to 190 m²/g, 8 g of dibutylphthalate as a phase separation agent, 0.13 g of isoquinoline as an imidizing agent, and 4 g of acetic anhydride as a dehydrating agent were added thereto, and then the foregoing composition was stirred to produce a transparent and uniform solution.

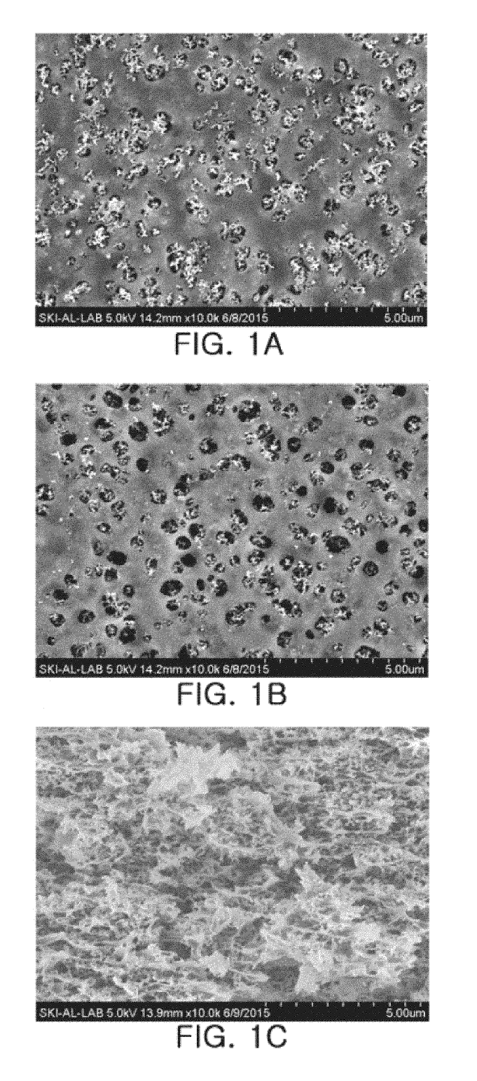

The subsequent process was carried out in the same manner as Example 1. The obtained physical properties of the microporous film are tabulated in Table 1 below. Images of surfaces (Air surface and PET surface) and a cross-section are illustrated in FIG. 1.

### Example 3

7 g of N,N-dimethylacetamide (DMAc) was added to 20 g of the poly(amic acid) solution as a solvent, 0.7 g of hydrophobic fumed silica (AEROSIL® R972 from Evonik Industries) with a specific surface area of 90 m²/g to 130 m²/g, 7.5 g of dibutylphthalate as a phase separation agent, 0.38 g of isoquinoline as an imidizing agent, and 4 g of acetic anhydride as a dehydrating agent were added thereto, and then the foregoing composition was stirred to produce a transparent and uniform solution.

The subsequent process was carried out in the same manner as Example 1. The obtained physical properties of the microporous film are tabulated in Table 1 below.

### Example 4

4 g of N,N-dimethylacetamide (DMAc) was added to 20 g of the poly(amic acid) solution as a solvent, 0.4 g of hydrophobic fumed silica (AEROSIL® R972 from Evonik Industries) with a specific surface area of 90 m²/g to 130 m²/g, 10.5 g of dibutylphthalate as a phase separation agent, 0.25 g of isoquinoline as an imidizing agent, and 5 g of acetic anhydride as a dehydrating agent were added thereto, and then the foregoing composition was stirred to produce a transparent and uniform solution.

The subsequent process was carried out in the same manner as Example 1. The obtained physical properties of the microporous film are tabulated in Table 1 below.

### Comparative Example 1

4 g of N,N-dimethylacetamide (DMAc) was added to 20 g of the poly(amic acid) solution as a solvent, and 10 g of dibutylphthalate as a phase separation agent and 4 g of acetic anhydride as a dehydrating agent were added thereto, and were then stirred to produce a transparent and uniform solution.

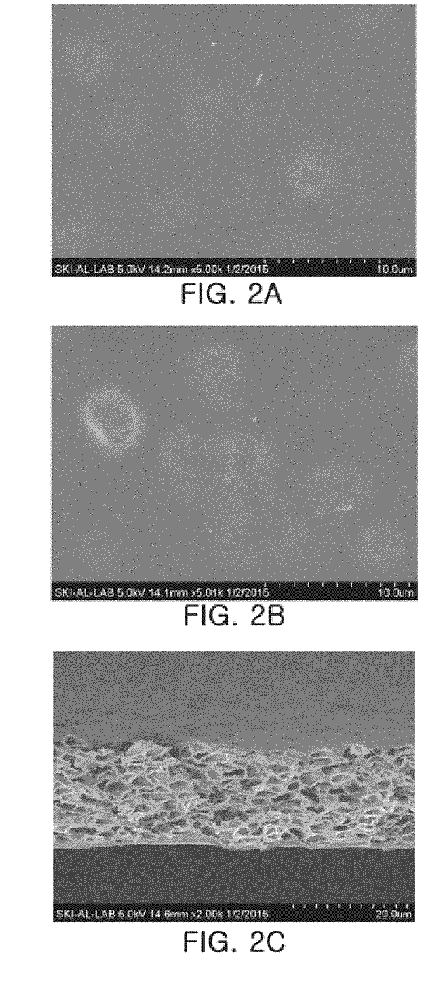

The subsequent process was carried out in the same manner as Example 1. The obtained physical properties of the microporous film are tabulated in Table 1 below. There was no permeability, so a pore size was not measurable. Images of surfaces (Air surface and PET surface) and a cross-section are illustrated in FIG. 2.

### Comparative Example 2

4 g of N,N-dimethylacetamide (DMAc) was added to 20 g of the poly(amic acid) solution as a solvent, and 0.5 g of hydrophobic fumed silica (AEROSIL® R972 from Evonik Industries) with a specific surface area of 90 m²/g to 130 m²/g, 9.5 g of dibutylphthalate as a phase separation agent and 4 g of acetic anhydride as a dehydrating agent were added thereto, and were then stirred to produce a transparent and uniform solution.

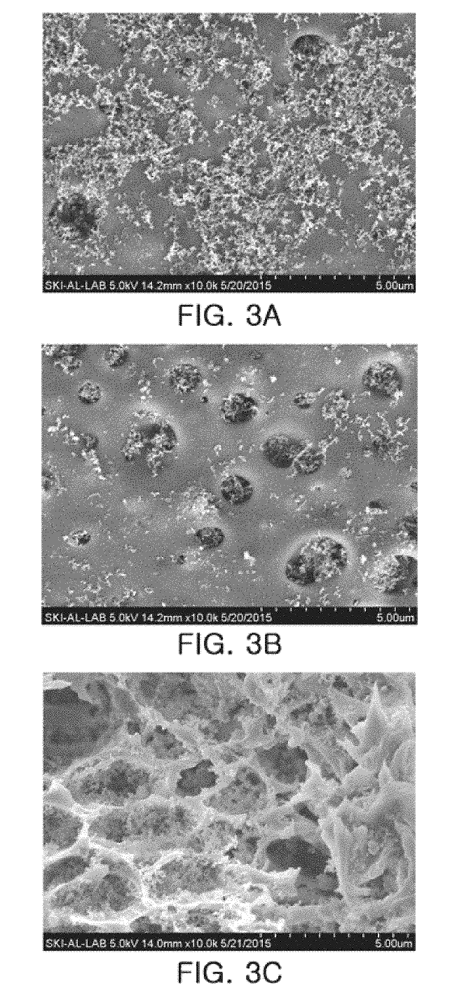

The subsequent process was carried out in the same manner as Example 1. The obtained physical properties of the microporous film are tabulated in Table 1 below. There was low permeability, so a pore size was not measurable. Images of surfaces (Air surface and PET surface) and a cross-section are illustrated in FIG. 3.

### Comparative Example 3

4 g of N,N-dimethylacetamide (DMAc) was added to 20 g of the poly(amic acid) solution as a solvent, and 0.6 g of hydrophobic fumed silica (AEROSIL® 200 from Evonik Industries) with a specific surface area of 175 m²/g to 250 m²/g, 10 g of dibutylphthalate as a phase separation agent, 0.19 g of isoquinoline as an imidizing agent, and 4 g of acetic anhydride as a dehydrating agent were added thereto, and were then stirred to produce a transparent and uniform solution.

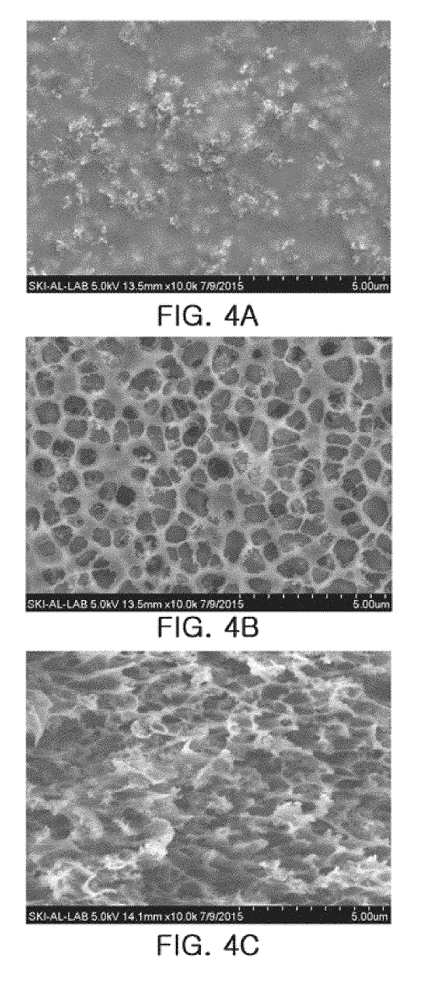

The subsequent process was carried out in the same manner as Example 1. There was no permeability, so a pore size was not measurable. The obtained physical properties of the microporous film are tabulated in Table 1 below. Images of surfaces (Air surface and PET surface) and a cross-section are illustrated in FIG. 4.

TABLE 1

| | | Puncture | Permeability | | | | |
|---|---|---|---|---|---|---|---|
| | Thickness | strength | (sec/100 cc/ | Porosity | Pore size (nm) | | shrinkage |
| | (μm) | (N/μm) | 20 μm) | (%) | Average | Maximum | ratio (%) |
| Example 1 | 20 | 0.11 | 400 | 53 | 40 | 95 | 0 |
| Example 2 | 21 | 0.10 | 130 | 56 | 53 | 80 | 1 |
| Example 3 | 23 | 0.11 | 250 | 54 | 36 | 60 | 0 |
| Example 4 | 18 | 0.12 | 300 | 55 | 59 | 100 | 0 |

| | | | | | | |
|---|---|---|---|---|---|---|
| Comparative | 25 | 0.10 | No | 70 | Not measurable | 0 |
| Example 1 | | | permeability | | | |
| Comparative | 17 | 0.15 | 2000 | 43 | Not measurable | 0 |
| Example 2 | | | | | | |
| Comparative | 20 | 0.10 | No | 60 | Not measurable | 0 |
| Example 3 | | | permeability | | | |

As set forth above, according to an exemplary embodiment, a method for producing a microporous polyimide-based film, having excellent thermal stability by including polyimide, having excellent strength and permeability to be applied to a separator for a battery, and having a proper pore size and structure so as to maintain battery cycle performance and charging characteristics of a battery, as well as a microporous polyimide-based film manufactured therefrom may be provided. Thus, a microporous polyimide-based film of the present invention may be suitably used for a high capacity/high power/high safety lithium ion secondary battery.

While exemplary embodiments have been shown and described above, it will be apparent to those skilled in the art that modifications and variations could be made without departing from the scope of the present invention as defined by the appended claims.

What is claimed is:

1. A method for producing a microporous polyimide-based film, comprising:
applying a polymer solution including poly(amic acid), a solvent for dissolving the poly(amic acid), a phase separation agent for phase-separation from the poly(amic acid), inorganic particles with a hydrophobized surface, an imidizing catalyst, and a dehydrating agent to a base material;
producing a phase-separated structure by drying the base material;
removing the phase separation agent from the phase-separated structure and producing a microporous film; and
imidizing unreacted poly(amic acid) by drying the microporous film.

2. The method for producing a microporous polyimide-based film of claim 1, wherein the producing the phase-separated structure is performed by conducting heat-drying for 1 to 30 minutes at a temperature of 60° C. to 150° C.

3. The method for producing a microporous polyimide-based film of claim 1, further comprising:
peeling the phase-separated structure from the base material before the phase separation agent is removed.

4. The method for producing a microporous polyimide-based film of claim 1, wherein the removing the phase separation agent is performed by conducting heat-drying for 5 to 60 minutes at a temperature of 150° C. to 400° C.

5. The method for producing a microporous polyimide-based film of claim 1, wherein the removing the phase separation agent is performed by extraction using one or more extractants selected from the group consisting of toluene, ethanol, ethyl acetate, heptane, liquefied carbon dioxide, and supercritical carbon dioxide.

6. The method for producing a microporous polyimide-based film of claim 4, wherein a residual phase separation agent in the microporous polyimide-based film is equal to or less than 1 wt % of a microporous film in which imidization is completed.

7. The method for producing a microporous polyimide-based film of claim 1, wherein the inorganic particles with a hydrophobized surface has a specific surface area of 20 m²/g to 500 m²/g.

8. A microporous polyimide-based film, including 4 wt % to 30 wt % of inorganic particles with a hydrophobized surface,
wherein a film thickness is 10 μm to 50 μm, puncture strength is 0.05 N/μm to 0.30 N/μm, permeability standardized at a thickness of 20 μm is 50 to 500 sec/100 cc, porosity is 40% to 65%, an average pore size measured using a half-dry method is 20 nm to 100 nm, a maximum pore size measured using a bubble point method is equal to or less than 300 nm, a shrinkage ratio at 200° C. is equal to or less than 5%.

9. The microporous polyimide-based film of claim 8, wherein the inorganic particles with a hydrophobized surface has a specific surface area of 20 m²/g to 500 m²/g.

10. The microporous polyimide-based film of claim 8, wherein a film thickness is 10 μm to 50 μm, puncture strength is 0.05 N/μm to 0.30 N/μm, permeability standardized at a thickness of 20 μm is 50 to 300 sec/100 cc, porosity is 45% to 60%, an average pore size measured using a half-dry method is 20 nm to 100 nm, a maximum pore diameter measured using a bubble point method is equal to or less than 200 nm, and a shrinkage ratio at 200° C. is less than 3%.

11. A battery, comprising the microporous polyimide-based film of claim 8 as a separator.
